(19) United States
(12) Patent Application Publication
(10) Pub. No.: US 2023/0396911 A1
(43) Pub. Date: Dec. 7, 2023

(54) TETHERING STRAP FOR WIRELESS EARPHONES

(71) Applicant: Apple Inc., Cupertino, CA (US)

(72) Inventors: Heather W. COX, Lise Angeles, CA (US); Vincenzo O. GIULIANI, Thousand Oaks, CA (US); Laura MOFFITT, Los Angeles, CA (US)

(21) Appl. No.: 17/805,540

(22) Filed: Jun. 6, 2022

(51) Int. Cl. H04R 1/10; A45F 5/00

(52) U.S. Cl. CPC H04R 1/1016; A45F 5/00; A45F 2005/006; A45F 2200/0508; H04R 2420/07

(57) ABSTRACT

An earphone tethering system may include first and second wireless earphones. Each wireless earphone may include a housing, a bud portion, and an earhook configured to wrap over and around a user's ear when in use, the earhook having an earhook tip that terminates a distal end of the earhook. A tethering strap may be included and releasably coupled to the respective earhook tips. The tethering strap may include a strap body, first and second tips formed from a stretchable material and having a receiving portion configured to receive and retain one of the first or second earhook tips, and first and second tethering elements configured to releasably couple the first and second tips such that the tethering strap is configured to be closed around a user's neck when the earhook is not wrapped around a user's ear.

### FIELD

The described embodiments relate generally to tethering straps for wireless earphones. More particularly, the present embodiments relate to a strap that may be used to join together wireless earphones. The strap may be an aesthetically pleasing and convenient addition to the wireless earphones that may join the wireless earphones together around a user's neck.

### BACKGROUND

The described embodiments relate generally to a tethering strap for wireless earphones, e.g., a strap that is optional such that a user may decide to couple the earphones together via the strap, or use them without the strap. Wireless earphones are convenient for users in many respects—they are easily worn, and different types are available for different user desires. For example, wireless earphones as described herein—including an earhook—provide additional security in terms of holding the earphone in place while the user is using them to listen to music while exercising, for example. For some, the feeling of the earhook around their ear has become what they expect when using wireless earphones.

In some situations, users may remove their wireless earphones, e.g., to talk to someone, listen for approaching traffic or other sounds, etc. In such situations, users may hold their earphones, or place them somewhere else such as on a table, in a pocket or bag. But holding or placing them away is not always a convenient solution, and misplaced earphones may result in loss of the product altogether. Finally, while branding opportunities on the earphones themselves exist, such as through logo display, color language, or simply the shape and overall design of the earphone, by including accessories further opportunities for branding or fashion choices exist. Thus, an opportunity to further enhance customer experience is ripe.

### SUMMARY

Some embodiments relate to an earphone tethering system, that may include a first wireless earphone, a second wireless earphone, and a tethering strap releasably couplable to the first and second wireless earphones. The tethering strap may include a strap body, a first tethering element, and a second tethering element. The first and second wireless earphones are couplable to the tethering strap, and the first and second tethering elements are securable to each other such that the first and second wireless earphones are held together.

In some embodiments, the tethering strap is configured to be worn around a user's neck. In some embodiments, the first and second tethering are securable to each other magnetically. In some embodiments, the tethering strap further includes a first tip and a second tip, each configured to receive an earhook tip of the first or second wireless earphone, respectively, such that the first and second wireless earphones are coupled to the tethering strap. In some embodiments, the first and second tips are made of silicone, and wherein the strap body is made of neoprene.

Some embodiments relate to a tethering strap for wireless earphones, which may include a strap body, first and second tips formed from a stretchable material and having a receiving portion configured to receive and retain one of a first or second earhook tips of wireless earphones, respectively, and first and second tethering elements configured to releasably couple the first and second tips such that the tethering strap is configured to be closed around a user's neck.

Some embodiments relate to a tethering strap for wireless earphones, including an elongated strap body having opposing ends, first and second tips each coupled to one of the opposing ends of the strap body. In some embodiments, each tip defines a cavity, and each of the cavities opens at a distal end of its respective tip. In some embodiments, each of the cavities has an internal dimension that is greater than a dimension of its opening. In some embodiments, the tethering strap includes a first magnetic tethering element coupled to the first tip.

In some embodiments, the tethering strap includes a second tethering element. the first and second tethering elements are securable to each other magnetically. In some embodiments, the first and second tips are made of silicone, and wherein the strap body is made of neoprene.

In some embodiments, the first and second tips each include a tip interface coupling the strap body to the first or second tip, respectively, and the tip interface is inserted into the strap body. In some embodiments, the first and second tips each include a tip interface coupling the strap body to the first or second tip, respectively, and the strap body is inserted into the tip. In some embodiments, the strap body and the first and second tips are integrally formed from the same material. In some embodiments, the material is silicone.

In some embodiments, the first tethering element comprises a magnet. In some embodiments, the receiving portion and the earhook tip have complimentary shapes such that the receiving portion includes a stopper shape such that the earhook tip cannot be pushed through the entirety of the tip. In some embodiments, the earhook tip is wingtip shaped, and the receiving portion includes a complimentary wingtip shape such that once the earhook tip is inserted into the receiving portion, the earhook tip is retained within the receiving portion. In some embodiments, the earhook tip is shaped such that the earhook tip is wider towards the distal end and bottom of the earhook tip, and the receiving portion comprises a complimentary shape to receive the earhook tip such that the opening of the receiving portion is narrower than a dimension further inside the receiving portion.

Some embodiments relate to a tethering strap for wireless earphones, that may include a strap body, first and second tips formed from a stretchable material and having a receiving portion configured to receive and retain a portion of a wireless earphone, and first and second tethering elements configured to releasably couple the first and second tips to each other, such that the tethering strap is configured to be closed around a user's neck when the wireless earphones are not in a user's ear, and is configured to be worn either in front of or behind a user's neck when the wireless earphones are in a user's ear.

In some embodiments, the first and second tethering elements include magnets embedded in the first and second tips, respectively. In some embodiments, the first and second tips are made of silicone, and wherein the strap body is made of neoprene. In some embodiments, the tethering strap may include a display surface comprising a branding element.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic view of wireless earphones, a tethering strap, and the wireless earphones and tethering strap being used by a user, in an embodiment.

FIG. 2 shows a rear view of the tethering strap shown in FIG. 1.

FIG. 3 shows a side view of the tethering strap shown in FIGS. 1 and 2.

FIG. 4 shows an enlarged view of a wireless earphone and tethering strap shown in FIGS. 1-3.

FIG. 5 shows a side view of another tethering strap, in an embodiment.

FIG. 6 shows a side view of another tethering strap, in an embodiment.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

What is needed is a paradigm that can improving the customer experience in providing a user an option to create a “tethered moment,” such as when exercising or coordinating their personal style, or exercising and needing to remove their earphones without setting them down, holding them in their hands, or putting them away in a pocket, case, or bag. The user's wireless earphones may be joined together via a strap as described herein, for example, coupled to the earhook or more particularly the earhook tip of the wireless earphones. And the strap may include a tethering element such as a pair of magnets that may secure the strap, and therefore the earphones, around a user's neck when the earphones are not being used.

The tethering straps described herein provide a solution to allow a user's wireless earphones to be joined together via a strap, and may include a tethering element such as a pair of magnets that may secure the strap, and therefore the earphones, around a user's neck when the earphones are not being used. Elements are described that achieve this security, while providing flexibility for use, and an intuitive mechanism for use.

As above, the described embodiments relate generally to wireless earphones with a tethering strap, e.g., one that is optional such that a user may decide to couple the earphones together via the strap, or use them without the strap. Particularly, wireless earphones including an earhook—especially for sports use—provide additional security in terms of holding the earphone in place while the user is using them to listen to music while exercising, for example. For some, the feeling of the earhook around their ear has become what they expect when using wireless earphones.

In some situations, users may remove their wireless earphones, e.g., to talk to someone, listen for approaching traffic or other sounds, etc. By providing a user an option to create a “tethered moment,” with a tethering strap, a user is free remove their earphones without setting them down, holding them in their hands, or putting them away in a pocket or bag. Instead, the user's wireless earphones may be joined together via a tethering strap including tethering element, such that the earphones may be worn around a user's neck when not being used. Additionally, streetwear style options and branding opportunities are increased for individuals to express their personal style, including changing the tethering strap out for different colors, patterns, shapes, etc.

These and other embodiments are discussed below with reference to the accompanying figures. However, those skilled in the art will readily appreciate that the detailed description given herein with respect to these figures is for explanatory purposes only and should not be construed as limiting.

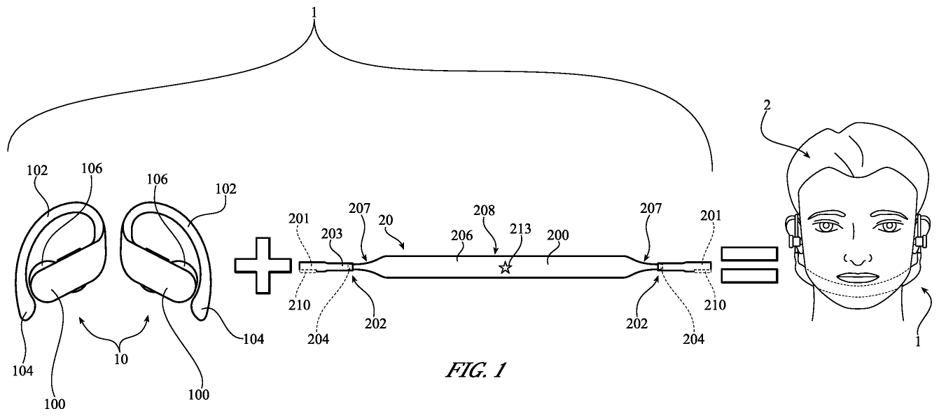

FIG. 1 shows first and second wireless earphones 10 and tethering strap 20, which together form earphone tethering earphone tethering system 1, which may be used, for example by a user 2 such as when user 2 desires to use wireless earphones 10. FIG. 1 shows an example of earphone tethering system 1 when wireless earphones 10 are being used by user 2, e.g., to listen to audio, or carry on a voice conversation via one or more microphones in wireless earphones 10. As shown, wireless earphones 10 may be cordless (i.e., there is no electrical or data wire or cord extending between wireless earphones 10, or from wireless earphones 10 to another device). First and second wireless earphones 10 may be releasably coupled to tethering strap 20, as described herein.

As shown in FIG. 1, wireless earphones 10 include a housing 100, a bud portion 106 (e.g., which may be inserted into user 2's ear and through which wireless earphones 10's speaker projects sound), and an earhook 102 configured to wrap over and around user 2's ear when bud portion 106 is placed into user 2's ear). Wireless earphones 10 also include an earhook tip 104, which terminates a distal end of earhook 102. As shown in the figures, earhook tip 104 may be a wingtip shape, such as, a flared end shape, where the shape gets wider in at least one dimension toward its distal end. In some embodiments, the wingtip shape may be generally more round and tubular toward the top of the earhook tip where it joins the body of the earhook, and flared, flatter, and wider towards the distal end and bottom of earhook tip 104. In some embodiments wireless earphones 10 may include one or more microphones, sensors, rechargeable batteries, connectors, and assorted wireless circuitry to allow for communication to and/or from an electronic device that receives and/or transmits audio data in communication with the earphones wirelessly, such as via Bluetooth, for example.

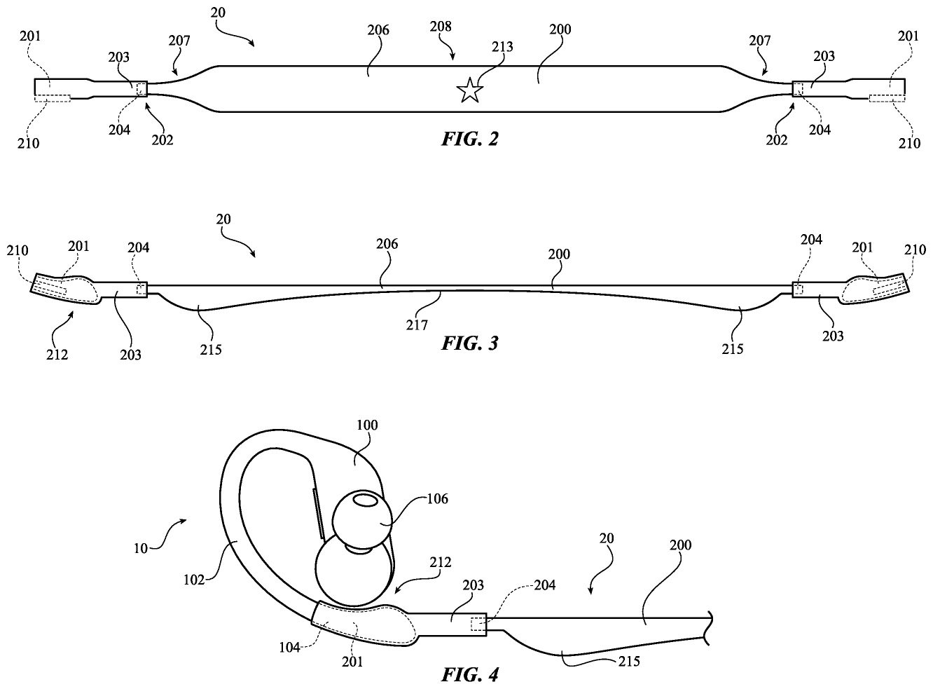

As shown in FIGS. 1-4, tethering strap 20 includes a strap body 208 having a central portion 200, and a tapered portion 207. A display surface 206 may be included, e.g., for branding element 213. Branding element 213 may be provided, for example, via screen-printing, adhesive stickers, debossing, embossing, texture, compound molding, etc. Tethering strap 20 further includes first and second tip interfaces 202, each of which includes an end 204 of strap body 208 and a region coupling end 204 to first and second tips 203, respectively. In some embodiments, strap body 208 is formed from a fabric material, such as neoprene. In some embodiments, using neoprene allows for a light tethering strap, and allows for a relatively thin and unobtrusive finished product. As shown in FIG. 1, tip interface 202 may be provided such that end 204 is inserted within tip 203. In some embodiments, adhesive may be used to secure end 204 to tip 203. In some embodiments, other features may be used to secure end 204 to tip 203, such as a mechanical lock, stitching, or interference fit. In some embodiments, no adhesive may be used to secure end 204 to tip 203.

Each of first and second tips 203 includes a receiving portion 201, configured to receive earhook tip 104. Each tip 203 also includes a tethering element 210 (e.g., a magnet, such as an ion magnet, permanent magnet, rare-earth magnet, neodymium magnet, etc.), such that a pair of tethering elements 210 are included on opposite sides of tethering strap 20. By positioning tethering elements 210 in tip 203 itself, it allows for earphone tethering system 1 to close in a loop at earhook tips 104 when earhook tips 104 are coupled to tethering strap 20 at tip interface 202. This avoids the need for including magnets in housing 100, and results in an optional accessory for a user. In some embodiments, tethering elements 210 operate via magnetism as described, and do not include mechanical fastening elements such as hook-and-loop elements, zippers, snaps, anoraks. This results in a cleaner and easier connection function that is not visually apparent. In some embodiments, tethering elements 210 may be embedded in a cavity in tip 203, or may be integrally molded therein. In some embodiments, tethering elements 210 are removable. In some embodiments, one tethering element 210 is a magnet, and the other tethering element 210 is attractable to the magnet (e.g., a magnetic material such as iron).

Tip 203 also includes a wingtip exterior shape 212, which leads into the portion of tip 203 that includes tip interface 202. In some embodiments, tip 203 is formed from a solid, yet flexible material, such as silicone. In this way, receiving portion 201 is configured to receive earhook tip 104 (e.g. as a cavity), which may stretch to accommodate earhook tip 104 and retain it via tension fit (or a type of snap fit or mechanical lock fit). This allows earhook tip 104 and receiving portion 201 to be releasably coupled. As shown in FIG. 4, for example, earhook tip 104 and receiving portion 201 as a cavity have complimentary shapes, such that receiving portion 201 closely follows the shape of earhook tip 104. In this way, earhook tip 104's wingtip shape is followed closely by the wingtip shape of receiving portion 201, that is, generally more round and tubular toward the top of the earhook tip where it joins the body of the earhook, and flared, flatter, and wider towards the distal end and bottom of earhook tip 104. Additionally, because earhook tip 104's wingtip shape is wider towards the distal end and bottom of earhook tip 104, the complimentary shape of receiving portion 201 includes a natural stopper shape such that earhook tip 104 cannot be pushed through the entirety of tip 203. This is shown in FIG. 4, for example, where the receiving portion ends in a smaller dimension towards the portion of tip 203 that extends towards tip interface 202 (which may be tubular, or solid). And due to earhook tip 104's wingtip shape being wider towards the distal end, once receiving portion 201 stretches around earhook tip 104, the releasable coupling provides a type of dimensional lock—that is the smaller dimension towards the opening of receiving portion 201 aids in securing wireless earphone 10 to tip 203 and thus tethering strap 20. Indeed, as shown in some embodiments, earhook tip 104 is wider towards the distal end and bottom of the earhook tip 104, and the receiving portion 201 includes a complimentary shape to receive the earhook tip 104 such that the opening of the receiving portion 201 is narrower than a dimension further inside the receiving portion. By configuring tip 203 in this way, a user may, at-will, easily pop the earphones in or out of earphone tethering system 1, whenever they want. The earhook tip 104 simply may be pushed-in or pulled-out in a simple operation, while ensuring that the ease of use in either direction is simple—while maintaining sufficient retention in a pushed-in configuration. For example, a user may want the earphone tethering system 1 to be connected for listening to music in an active context like jogging, but take easily uncouple when sitting listening to an audiobook while commuting on the subway.

While both earhook tip 104's and receiving portion 201's shapes have been described as “wingtip shape,” in some embodiments, earhook tip 104 and receiving portion 201 may have other shapes, such as a square shape, a triangle shape, curved shape, etc., such that they are complimentary and are sufficient to couple earhook tip 104 to tip 203, thus joining wireless earphone 10 and tethering strap 20.

In some embodiments, strap body 208 is the same material as tip 203. In some embodiments, strap body 208 is a different material as tip 203. By using different materials in some embodiments, different goals may be achieved, such as using neoprene in strap body 208 for use against the neck for comfort and wicking, with silicone at the tips 203 so they can be molded and have a secure fit on the earphones. Additionally, screenprinting logos or other branding may be useful in some materials for the strap, but other options such as molding logos or other branding may be attractive in other contexts. In some embodiments, the materials used to make components of tethering strap 20 are waterproof, thereby increasing their durability when in use (e.g., by protecting against sweat).

When user 2 decides to remove wireless earphones 10, e.g., to talk to someone, listen for approaching traffic or other sounds, etc., they may remove bud portion 106 and earhook 102 from both ears, and place wireless earphones 10 around their neck (e.g., so tethering strap rests on the back of their neck). In this way, user 2 creates a “tethered moment,” where tethering elements 210 are temporarily used to fasten earphone tethering system 1 around their neck such that they are free to remove their wireless earphones 10 without setting them down, holding them in their hands, or putting them away in a pocket or bag. Indeed, by using magnets (such as ion magnets) as tethering elements 210, a user may magnetize tethering strap 20 closed—by tethering tips 203 to each other in front of a user's neck (e.g., similar to a necklace). Additionally, closing tethering strap 20 around another element for safekeeping is also possible, such as around the handle of a gym bag, hook in a locker, etc.

FIG. 3 shows a side view of tethering strap 20, and shows wingtip exterior shape 212 and the shape of receiving portion 201. As shown, exterior shape 212 may match interior shape of receiving portion 201. This allows for, for example, consistent wall thickness for consistent stretch when inserting/removing earhook tips 104, and aesthetic ally pleasing design, since they are continuing the aesthetic of the earphone itself. Additionally, FIG. 3 shows how tethering strap 20 may include, in some aspects, a thinned region 206, and a thickened region 215—these regions may be solid, and provide a unique design characteristic for tethering strap 20. These regions additionally may provide comfort and padding to a user's neck, and may have different appearances to achieve this. In an embodiment where tethering strap 20 may be formed from multiple layers, however, the lengths of the surfaces that define thinned region 206 and thickened region 215 may allow for uniform thickness when earphone tethering system 1 is being used around a user's neck (e.g., by taking up slack on the outer, slightly longer, curved surface created when in use). Curvature 217 is also shown, and in some embodiments may either face the user's neck, or away from the user's neck, when in use.

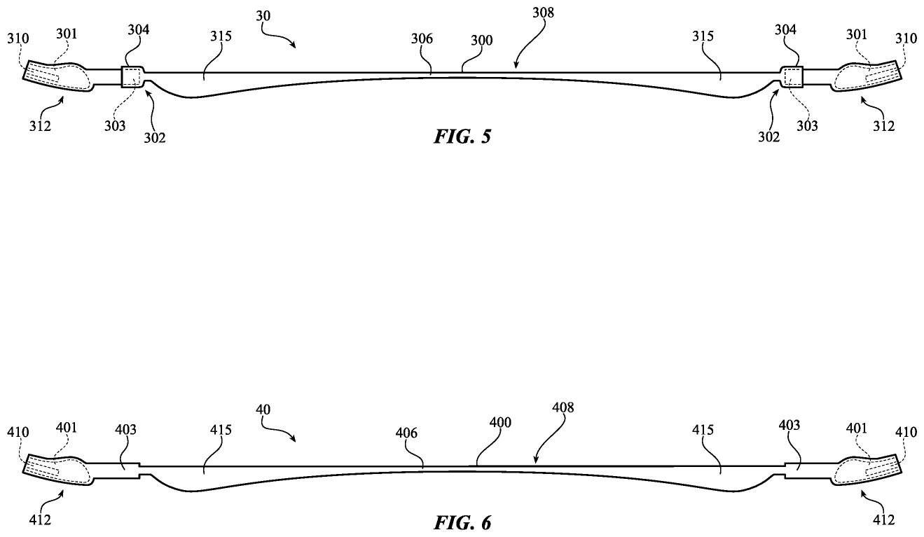

FIG. 5 shows a side view of another tethering strap 30. Except as otherwise described, tethering strap 30 includes all of the same features and functions substantially the same as tethering strap 20, described above. That is, tethering strap 30 includes a strap body 308 having a central portion 300, and a tapered portion similar to tapered portion 207. A display surface 306 may be included, e.g., for a branding element. Tethering strap 30 further includes a tip interface 302, which includes an end 304 of strap body 308 and a region coupling end 304 to a tip 303. In some embodiments, strap body 308 is formed from a fabric material, such as neoprene. In contrast to tethering strap 20, tip interface 302 may be provided such that tip 303 is inserted within end 304. In some embodiments, adhesive may be used to secure end 304 to tip 303. In some embodiments, other features may be used to secure end 304 to tip 303, such as a mechanical lock, stitching, or interference fit. In some embodiments, no adhesive may be used to secure end 304 to tip 303. Tip 303 includes a receiving portion 301, configured to receive earhook tip 104, as described above. Tip 303 also includes a tethering element 310 (e.g., a magnet, such as an ion magnet), such that a pair of tethering elements 310 are included on opposite sides of tethering strap 30. By positioning tethering elements 310 in tip 303 itself, it allows for earphone tethering system 1 to close in a loop at earhook tip 104 when earhook tip 104 is coupled to tethering strap 30 at tip interface 302. This avoids the need for including magnets in housing 100, and results in an optional accessory for a user. In some embodiments, tethering elements 310 do not include elements such as hook-and-loop elements, zippers, snaps, anoraks. In some embodiments, tethering elements 310 may be embedded in a cavity in tip 303, or may be integrally molded therein. In some embodiments, tethering elements 310 are removable.

Tip 303 also includes a wingtip exterior shape 312, which leads into the portion of tip 303 that includes tip interface 302. In some embodiments, tip 303 is formed from a solid, yet flexible material, such as silicone. Tip 303 includes receiving portion 301.

FIG. 6 shows a side view of another tethering strap 40. Except as otherwise described, tethering strap 40 includes all of the same features and functions substantially the same as tethering strap 20, described above. That is, tethering strap 40 includes a strap body 408 having a central portion 400, and a tapered portion similar to tapered portion 207. A display surface 406 may be included, e.g., for a branding element. Tethering strap 40 further includes a tip interface 402, which includes a transition region between end 404 of strap body 408 and a region bridging end 404 to a tip 403. In contrast to tethering strap 20/30, tethering strap 40 is formed from a single material, such as silicone.

Tip 403 includes a receiving portion 401, configured to receive earhook tip 104, as described above. Tip 403 also includes a tethering element 410 (e.g., a magnet, such as an ion magnet), such that a pair of tethering elements 410 are included on opposite sides of tethering strap 40. By positioning tethering elements 410 in tip 403 itself, it allows for earphone tethering system 1 to close in a loop at earhook tip 104 when earhook tip 104 is coupled to tethering strap at tip interface 402. This avoids the need for including magnets in housing 100, and results in an optional accessory for a user. In some embodiments, tethering elements 410 do not include elements such as hook-and-loop elements, zippers, snaps, anoraks. In some embodiments, tethering elements 410 may be embedded in a cavity in tip 403, or may be integrally molded therein. In some embodiments, tethering elements 410 are removable. Tip 403 also includes a wingtip exterior shape 412. Tip 403 includes receiving portion 401.

As can be appreciated, the dimensions of the constituent components of the wireless earphones 10 and tethering straps 20/30/40 may be varied to accommodate different sizes and shapes of products or product variants (e.g., across wireless earphone product lines, or to accommodate various lengths or dimensions of tethering strap product lines). But while the dimensions and shapes may vary, the design may be scaled such that assembly is substantially the same, notwithstanding any dimensional differentiation.

Each of the components and their constituent parts, and other variations described herein may include corresponding features described with reference to each of the other components and features described without limitation.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. An earphone tethering system, comprising:
a first wireless earphone;
a second wireless earphone; and
a tethering strap releasably couplable to the first and second wireless earphones, the tethering strap comprising:
a strap body;
a first tethering element; and
a second tethering element,
wherein when the first and second wireless earphones are coupled to the tethering strap, the first and second tethering elements are securable to each other such that the first and second wireless earphones are held together.

2. The system of claim 1, wherein the tethering strap is configured to be worn around a user's neck.

3. The system of claim 1, wherein the first and second tethering are securable to each other magnetically.

4. The system of claim 1, wherein the tethering strap further comprises:
a first tip and a second tip, each configured to receive an earhook tip of the first or second wireless earphone, respectively, such that the first and second wireless earphones are coupled to the tethering strap.

5. The system of claim 4, wherein the first and second tips are made of silicone, and wherein the strap body is made of neoprene.

6. A tethering strap for wireless earphones, comprising:
an elongated strap body having opposing ends;
first and second tips each coupled to one of the opposing ends of the strap body, wherein each tip defines a cavity, wherein each of the cavities opens at a distal end of its respective tip, and wherein each of the cavities has an internal dimension that is greater than a dimension of its opening; and;
a first magnetic tethering element coupled to the first tip.

7. The tethering strap of claim 6, wherein the first and second tethering elements are magnetically securable to each other around a user's neck.

8. The tethering strap of claim 6, wherein the first and second tips are made of silicone, and wherein the strap body is made of neoprene.

9. The tethering strap of claim 6, wherein the first and second tips each include a tip interface coupling the strap body to the first or second tip, respectively, and wherein the tip interface is inserted into the strap body.

10. The tethering strap of claim 6, wherein the first and second tips each include a tip interface coupling the strap body to the first or second tip, respectively, and wherein the strap body is inserted into the tip.

11. The tethering strap of claim 6, wherein the strap body and the first and second tips are integrally formed from the same material.

12. The tethering strap of claim 11, wherein the material is silicone.

13. The tethering strap of claim 6, wherein the second tethering element comprises a magnet.

14. The tethering strap of claim 6, wherein the receiving portion and the earhook tip have complimentary shapes such that the receiving portion includes a stopper shape such that the earhook tip cannot be pushed through the entirety of the tip.

15. The tethering strap of claim 6, wherein the earhook tip is wingtip shaped, and wherein the receiving portion comprises a complimentary wingtip shape such that once the earhook tip is inserted into the receiving portion, the earhook tip is retained within the receiving portion.

16. The tethering strap of claim 6, wherein the earhook tip is shaped such that the earhook tip is wider towards the distal end and bottom of the earhook tip, and wherein the receiving portion comprises a complimentary shape to receive the earhook tip such that the opening of the receiving portion is narrower than a dimension further inside the receiving portion.

17. A tethering strap for wireless earphones, comprising:
a strap body;
first and second tips formed from a stretchable material and having a receiving portion configured to receive and retain a portion of a wireless earphone; and
first and second tethering elements configured to releasably couple the first and second tips to each other, such that the tethering strap is configured to be closed around a user's neck when the wireless earphones are not in a user's ear, and is configured to be worn either in front of or behind a user's neck when the wireless earphones are in a user's ear.

18. The tethering strap of claim 17, wherein the first and second tethering elements comprise magnets embedded in the first and second tips, respectively.

19. The tethering strap of claim 18, wherein the first and second tips are made of silicone, and wherein the strap body is made of neoprene.

20. The tethering strap of claim 17, further comprising a display surface comprising a branding element.
